(19) United States
(12) Patent Application Publication
(10) Pub. No.: US 2024/0090011 A1
(43) Pub. Date: Mar. 14, 2024

(54) TIME SENSITIVE NETWORK (TSN) QUALITY OF SERVICE (QOS) MANAGEMENT

(71) Applicant: Cisco Technology, Inc., San Jose, CA (US)

(72) Inventors: Malcolm Muir Smith, Richardson, TX (US); Maik Guenter Seewald, Nürnberg (DE); Robert E. Barton, Richmond (CA)

(73) Assignee: Cisco Technology, Inc., San Jose, CA (US)

(21) Appl. No.: 17/932,066

(22) Filed: Sep. 14, 2022

(51) Int. Cl. H04W 72/12; H04W 28/02

(52) U.S. Cl. CPC H04W 72/1231; H04W 28/0268

(57) ABSTRACT

Time Sensitive Network (TSN) Quality of Service (QoS) management may be provided. A number of Transmit Opportunities (TxOPs) to use for transmitting data between an Access Point (AP) and a client device over a wireless link may be received. An initial gate configuration to the AP for transmitting data between the AP and the client device over the wireless link for a transmit period of each cycle of a number of cycles may be provided based on the number of TxOPs. A change in a network condition of the wireless link may be detected. The initial gate configuration for the transmit period in a current cycle of the number of cycles may be adjusted in response detecting the change in the network condition of the wireless link.

### TECHNICAL FIELD

The present disclosure relates generally to time sensitive networks.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, that is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Time Sensitive Network (TSN) Quality of Service (QoS) management;

FIG. 2 is a flow chart of a method for providing TSN QoS management;

FIG. 3 is a state diagram for providing TSN QoS management; and

FIG. 4 is a block diagram of a computing device.

### DETAILED DESCRIPTION

### Overview

Time Sensitive Network (TSN) Quality of Service (QoS) management may be provided. A number of Transmit Opportunities (TxOPs) to use for transmitting data between an Access Point (AP) and a client device over a wireless link may be received. An initial gate configuration to the AP for transmitting data between the AP and the client device over the wireless link for a transmit period of each cycle of a number of cycles may be provided based on the number of TxOPs. A change in a network condition of the wireless link may be detected. The initial gate configuration for the transmit period in a current cycle of the number of cycles may be adjusted in response detecting the change in the network condition of the wireless link.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A Time Sensitive Network (TSN) may be a set of Institute of Electrical and Electronics Engineers (IEEE) 802 Ethernet sub-standards that are defined by the IEEE TSN task group. These standards may enable deterministic real-time communication over Ethernet. TSN may achieve determinism over the Ethernet by using time synchronization and a transmission schedule that may be shared between network components. By defining gates based on time for scheduled transmission of frames assigned for queues associated with pre-defined traffic classes, Time Sensitive Networking may ensure a bounded maximum latency for scheduled traffic through switched networks. This may mean that in a TSN, latency of a critical scheduled communication may be guaranteed.

In control applications with strict deterministic requirements, such as those found in automotive and industrial domains, TSN may offer a way to send time-critical traffic over a standard Ethernet infrastructure. This may enable the convergence of all traffic classes and multiple applications in one network. In practice this may mean that the functionality of standard Ethernet may be extended so that message latency may be guaranteed through switched networks. Critical and non-critical traffic may be converged in one network, and higher layer protocols may share the network infrastructure.

Establishing TSN in wireless (e.g., Wi-Fi) environments may however be complex. For example, in open mines, trucks (i.e., stations) may need TSN data exchanges for real time automated driving functions. The amount of data that is to be exchanged may be known and predictable. The truck, however, may be moving and the Radio Frequency (RF) signal may be constantly changing. In such an environment, a late condition may appear, where a TSN controller may instruct a scheduler to allocate Resource Unites (RUs) based on the truck's current data rate, but the truck may move and may fail to obtain the bandwidth it really needed for the current data burst.

When the truck is approaching an Access Point (AP), or moving to a region of low RF variability, this may result in wasted bandwidth. In other words, the truck may have finished transmitting the useful information before the end of the allocated schedule and may end up sending empty padding to complete the schedule. When the truck is moving away from the AP, or through a region of high RF variability (e.g., destructive interference, or other metallic objects on the path causing large signal stochasticity), this may result in data lost (not transmitted), that may be problematic.

While wireless (e.g., Wi-Fi 6 or Wi-Fi 7) may be an accessible solution, the same challenge mentioned above may be experienced by a host of other TSN applications where RF conditions may vary. In an industrial domain of Operational Technology (OT), for example, Industrial Internet of Things (IIoT), using IEEE802.1/TSN technology, a Quality of Service (QoS) management architecture may allow control of TSN bridges (e.g., an AP) via a Central Network Controller (CNC). The CNC may manage time-schedule of TSN nodes within a Wireless Local Area Network (WLAN). QoS information regarding TSN flows may be provided via a Central User Controller (CUC). The CUC may interact with endpoints via an Open Platform Communication (OPC) United Architecture (UA) protocol or via Electronic Data Sheets (EDS), for example. Both of these management elements (i.e., the CNC and the CUC) may be unique to TSN and may not have any relationship to an enterprise management architecture (e.g., a Digital Network Architecture Center (DNAC) or a Software-Defined Network (SDN)).

In TSN, stochastic performance of a wireless link to the CNC may be represented via a link delay variability parameter. The CNC may query the link delay and act upon by altering an end-to-end IEEE 802.1Qbv TSN time-slot/gate schedule. However, the link delay of a wireless link may change quickly, and the CNC may not be able to keep up with these changes. For example, every time a client device moves between APs or a data-rate changes, the link delay may spike up, and the CNC may over-react by adjusting affected up/down-stream TSN gates. The link delay may then subside, and the CNC may correct the gates accordingly by re-adjusting affected up/down-stream TSN gates. This process may be slow relative to a dynamic nature of the wireless link and may be disruptive to other TSN end nodes. Therefore, an alternate, approach may be needed that may minimize end node impact.

Embodiments of the disclosure may provide an enterprise centric TSN QoS management process. An enterprise controller (e.g., a SDN or a DNAC controller) may receive time-slot/gate assignment from the CNC. The enterprise controller may return a gate assignment for the CUC and the end-nodes (that is, an assignment of which time-slots may be available to use). Using the gate assignment, the enterprise controller may influence the time-slot schedule that is programmed into an AP.

The enterprise controller may comprise two components: (1) a quasi-static Non-Real-Time (NRT) scheduler; and (2) a dynamic Real-Time (RT) scheduler. The NRT scheduler may react in a longer time frame (e.g., units of seconds) and may be suitable for human interaction (e.g., where a user may view statistics as it evolves, modify QoS policy, etc). The RT scheduler may be autonomous and may react in a shorter time frame (e.g., units of milliseconds). The RT scheduler may use Machine Learning/Reinforcement Learning (ML/RL) techniques for adaptation. The RT scheduler may be located at a network edge close to the WiFi TSN bridge (i.e., an AP) and may communicate state changes relevant to the NRT scheduler over NRT pipes.

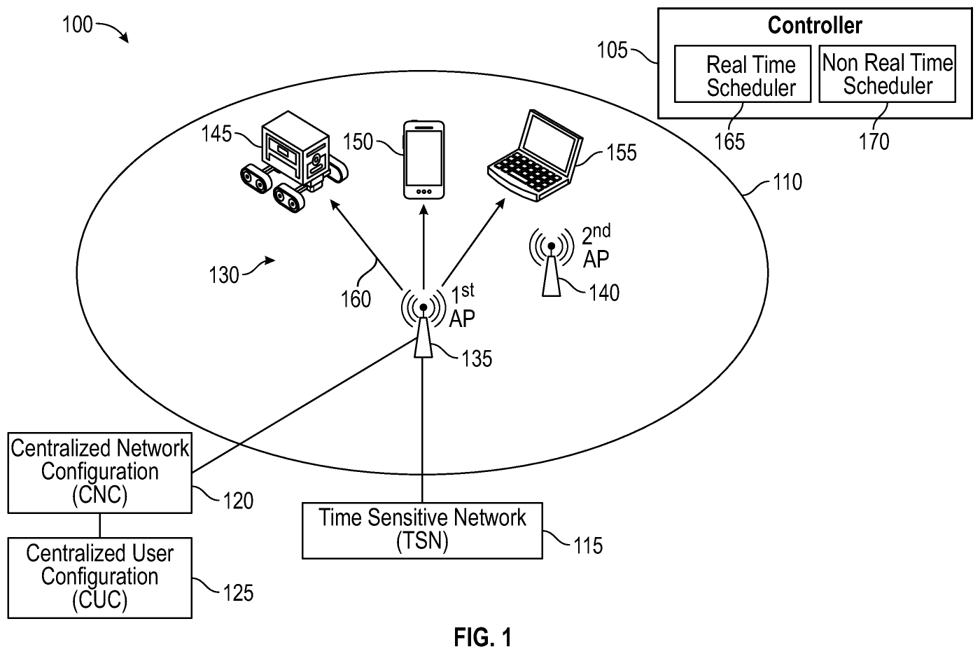

FIG. 1 shows an operating environment 100 for providing TSN QoS management. As shown in FIG. 1, operating environment 100 may comprise a controller 105, a coverage environment 110, a TSN 115, a CNC 120 server, and a CUC 125 server. Coverage environment 110 may be a RF environment (i.e., Wi-Fi 6, Wi-Fi 7, etc.) and may comprise, but is not limited to, a WLAN comprising a plurality of stations 130. Plurality of stations 130 may comprise a plurality of APs and a plurality of client devices. The plurality of APs may provide wireless network access (e.g., access to the WLAN) for the plurality of client devices. The plurality of APs may comprise a first AP 135 and a second AP 140. Each of the plurality of APs may be compatible with specification standards such as, but not limited to, the IEEE 802.11 specification standard for example.

CUC 125 may obtain requirements from end-devices (e.g., plurality of stations 130) or may detect transmission availability based on sensor data. Once communication relations between sending devices (i.e., talkers) and receiving devices (i.e., listeners) has been established, that information may be transferred to CNC 120. CNC 120 may have full and global knowledge of network resources and topology. CNC 120 may then use this information to find a data path that fits the communication requirements between a talker and a listener. CNC 120 may provide scheduling information (e.g., Orthogonal Frequency-Division Multiple Access (OFDMA) scheduling information) to controller 105.

Ones of the plurality of client devices may comprise, but are not limited to, a controller, an actuator, a sensor, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, an Unmanned Aerial Vehicle (UAV), or other similar microcomputer-based device. In the example shown in FIG. 1, the plurality of client devices may be TSN devices and may comprise a first client device 145 (e.g., a mining haul truck), a second client device 150 (e.g., a smart phone), and a third client device 155 (e.g., a laptop computer). A client device (e.g., first client device 145) of the plurality of client devices may communicate with one or more of the plurality of APs (e.g., first AP 135) over a wireless link 160.

Controller 105 may communicate with CNC 120 and control the wireless network (i.e., the WLAN) comprising plurality of APs for example. In other words, controller 105 may schedule TSN transmissions in the wireless network comprising the plurality of APs. Controller 105 may comprise a Wireless Local Area Network controller (WLC) and may provision coverage environment 110 (e.g., the WLAN). Controller 105 may allow the plurality of client devices to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide TSN QoS management. Controller 105 may comprise a Real Time (RT) scheduler 165 and a Non-Real Time (NRT) scheduler 170.

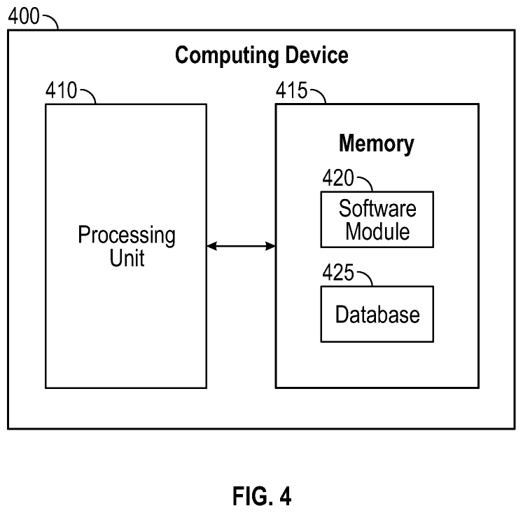

The elements described above of operating environment 100 (e.g., controller 105, CNC 120, CUC 125, first AP 135, second AP 140, first client device 145, second client device 150, third client device 155, RT scheduler 165, and a NRT scheduler 170) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

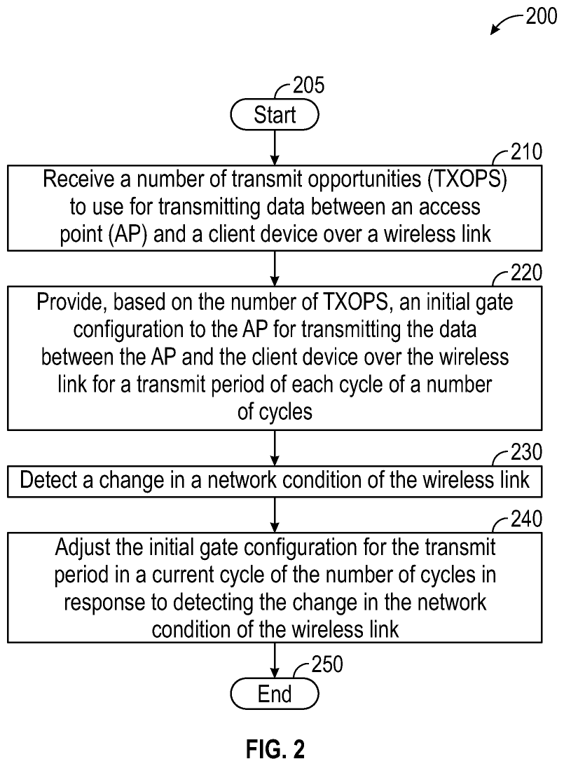

FIG. 2 is a flow chart setting forth the general stages involved in a method 200 consistent with an embodiment of the disclosure for providing a TSN QoS management. Method 200 may be implemented using controller 105 that may be embodied by a computing device 400 as described in more detail below with respect to FIG. 4. Ways to implement the stages of method 200 will be described in greater detail below.

Method 200 may begin at starting block 205 and proceed to stage 210 where controller 105 may receive a number of Transmit Opportunities (TxOPs) for transmitting data between an AP (e.g., first AP 135) and a client device (e.g., first client device 145) over wireless link 160. CNC 120 may determine the number of TxOPs based on QoS requirements for communication between first AP 135 and first client device 145 and a Radio Frequency (RF) profile associated with first client device 145.

CNC server 120 may receive the QoS requirements from a management and engineering tool or from CUC 125. The QoS requirements may comprise a time window (e.g., representing the bounded latency) in which data is expected by the applications hosted on first client device 145. In addition, the QoS requirements may comprise the communication relations represented by a stream (e.g., sent from a sender/talker to a receiver/listener). Time windows may differ depending on the application requirements.

CNC 120 may receive a Radio Frequency (RF) profile associated with first client device 145. For example, first AP 135 may send a message to first client device 145. In response, first client device 145 may provide the RF profile that reports the stochasticity of RF signals (i.e., the RF instability) in the area first client device 145 is currently in. For example, first client device 145 may report to first AP 135 several data points of Received Signal Strength Indicators (RSSIs) received from first AP 135 as the RF profile.

CNC 120 may determine a number of TxOPs to use for transmitting data between first AP 135 and first client device 145 based on one or more of the RF profiles and the QoS requirements. For example, CNC 120 may determine a data rate that may be supported by wireless link 160 during a next scheduled data interval. CNC 120 may know how much data that needs to be transmitted over the next scheduled data interval, and now that it may also know the data rate that may be supported by wireless link 160 during the next scheduled data interval, CNC 120 may determine the number of TxOPs (e.g., RUs) that may need to be allocated for the next scheduled data interval. The next scheduled data interval may include a predetermined number of cycles. CNC 120 may send the number of TxOPs to controller 105.

Once controller 105 receives the number of TxOPs to use for transmitting the data over wireless link 160 in stage 210, method 200 may continue to stage 220 where controller 105 may provide an initial gate configuration to first AP 135 based on the number of TxOPs for transmitting the data between first AP 135 and first client device 145 over wireless link 160. For example, NRT scheduler 170 of controller 105 may provide the initial gate configuration to first AP 135 for a transmit period of each cycle of a number of cycles for the transmission between first AP 135 and first client device 145 according to the number of TxOPs determined by CNC 120.

From stage 220, where controller 105 provides the initial gate configuration to first AP 135 for transmitting the data between first AP 135 and first client device 145, method 200 may advance to stage 230 where controller 105 may detect a change in a network condition of wireless link 160. As transmission begins, the network condition of wireless link 160 may continually be monitored. Wireless link 160 may be stochastic, and even if the agreed transmission schedule may be possible at a time to, it may not be possible at a later time (i.e., time tn), breaking latency requirements of TSN 115. This may be a likely scenario as first client device 145 may likely be mobile or in motion and may experience changing network conditions. Considering this, in an effort to ensure the transmission schedule may continually be met, first AP 135 or controller 105 may continually refresh monitoring of the network condition of wireless link 160 faster than first client device 145 may move. For example, if the network condition is degrading, if all other variables are held constant, it may become difficult for first client device 145 and first AP 135 to meet the transmission schedule. To address this, controller 105 may anticipate, learn, and predict a change of the network condition. Controller 105, for example, may detect the change in the network condition of the wireless link based on a derivative of a RSSI received from first client device 145. Controller 105 may predict the network condition of the wireless link based on tracking past movements of first client device 145 and obtaining stochasticity of a signal received from first client device 145 at different points in its past movement.

Once controller 105 detects change in the network condition of wireless link 160 in stage 230, method 200 may continue to stage 240 where controller 105 may adjust the initial gate configuration for the transmit period in a current cycle of the number of cycles. For example, RT scheduler 165 of controller 105 may dynamically reschedule the initial gate configuration for the transmit period in response to a data rate change, retry count change, mobility, etc. in wireless link 160. For example, RT scheduler 165 may free up one or more gates when not all gates are being used to transmit data. RT scheduler 165 may reschedule the initial gate configuration independent of NRT scheduler 170. From stage 240, where controller 105 adjusts the initial gate configuration for the transmit period in the current cycle of the number of cycles, method 200 may then end at stage 250.

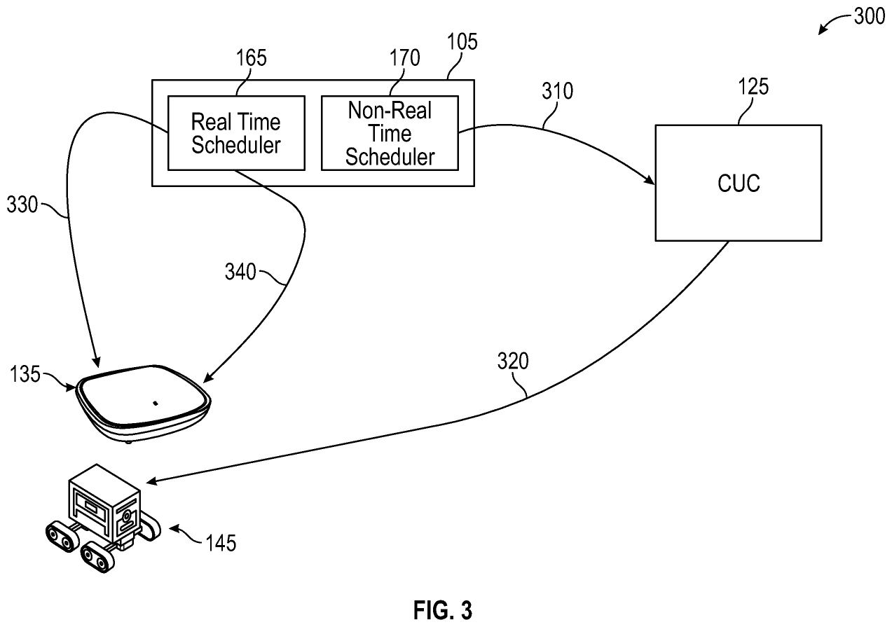

FIG. 3 is a state diagram 300 of a TSN QoS management process. Stages of state diagram 300 may be implemented using controller 105 (e.g., RT scheduler 165 and NRT scheduler 170) and CUC 125 as described in more detail above with respect to FIG. 1. Ways to implement the stages of state diagram 300 will be described in greater detail below.

At stage 310 of state diagram 300 NRT scheduler 170 may allocate a generous time budget to RT scheduler 165 out of an overall TSN schedule for a TSN flow that traverses first AP 135. For example, a 1 ms latency budget may be met via a 10 μs gate for an Ethernet node followed by an 890 μs gate allowance for the WiFi node including 100 μs for the transmission (i.e., 890 μs extra time budget) followed by a 100 μs gate for an Ethernet switch.

At stage 320 of state diagram 300, CUC 125 may provide the IEEE 802.1Qbv schedule to first client device 145. CUC 125 may, for example, program a corresponding IEEE 802.1Qbv TSN talker schedule.

At stage 330 of state diagram 300, RT scheduler 165 may provide an initial gate configuration to first AP 135. RT scheduler 165, for example, may provide an initial gate configuration to first AP 135 using the first 100 μs of the 1 ms budget.

At stage 340 of state diagram 300, RT scheduler 165 may provide a dynamic IEEE 802.1Qbv gate compensation to first AP 135. For example, as first client device 145 moves (i.e., as rapid data-rate changes/retries/mobility/etc. events occur), RT scheduler 165 may use the time budget to compensate by dynamically re-scheduling IEEE 802.1 Qbv gates/slots between first AP 135 and first client device 145 independent of the NRT scheduler 170. With this two-tier orchestration, the network condition changes may be absorbed by RT scheduler 165, resulting in a minimal impact to downstream end nodes and thus a more consistent user experience (i.e., constant latency/jitter).

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing a TSN QoS management described with respect to FIG. 2 and FIG. 3. Computing device 400, for example, may provide an operating environment for controller 105, CNC 120, CUC 125, first AP 135, second AP 140, first client device 145, second client device 150, third client device 155, RT scheduler 165, and NRT scheduler 170. Controller 105, CNC 120, CUC 125, first AP 135, second AP 140, first client device 145, second client device 150, third client device 155, RT scheduler 165, and NRT scheduler 170 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving a number of Transmit Opportunities (TxOPs) to use for transmitting data between an Access Point (AP) and a client device over a wireless link;
providing, based on the number of TxOPs, an initial gate configuration to the AP for transmitting data between the AP and the client device over the wireless link for a transmit period of each cycle of a number of cycles;
detecting a change in a network condition of the wireless link; and
adjusting the initial gate configuration for the transmit period in a current cycle of the number of cycles in response detecting the change in the network condition of the wireless link.

2. The method of claim 1, wherein providing the initial gate configuration to the AP comprises providing the initial gate configuration by a Non-Real Time (NRT) scheduler for the transmit period of each cycle of the number of cycles.

3. The method of claim 1, wherein adjusting the initial gate configuration in response detecting the change in the network condition of the wireless link comprises adjusting the initial gate configuration for the transmit period in a current cycle of a number of cycles by a Real Time (RT) scheduler.

4. The method of claim 1, wherein detecting the change in the network condition of the wireless link comprises detecting the change in the network condition of the wireless link based on a derivative of a Received Signal Strength Indicator (RSSI) received from the client device.

5. The method of claim 1, wherein detecting the change in the network condition of the wireless link comprises predicting the network condition of the wireless link based on tracking past movements of the client device and obtaining stochasticity of a signal received from the client device at different points in its past movement.

6. The method of claim 1, wherein receiving the number of TxOPs to use for transmitting data between the AP and the client device over the wireless link comprises receiving the number of TxOPs from a Central Network Controller of a Time Sensitive Network (TSN).

7. The method of claim 1, wherein receiving the number of TxOPs to use for transmitting data between the AP and the client device over the wireless link comprises receiving the number of TxOPs for transmitting the data between the AP and the client device that is in motion.

8. The method of claim 1, wherein receiving the number of TxOPs to use for transmitting data between the AP and the client device over the wireless link comprises receiving the number of TxOPs to use for transmitting the data between the AP and the client device based on a Radio Frequency (RF) profile associated with the wireless link.

9. A system comprising:
a memory storage; and
a processing unit coupled to the memory storage, wherein the processing unit is operative to:
receive a number of Transmit Opportunities (TxOPs) to use for transmitting data between an Access Point (AP) and a client device over a wireless link;
provide, based on the number of TxOPs, an initial gate configuration to the AP for transmitting data between the AP and the client device over the wireless link for a transmit period of each cycle of a number of cycles;
detect a change in a network condition of the wireless link; and
adjust the initial gate configuration for the transmit period in a current cycle of the number of cycles in response detecting the change in the network condition of the wireless link.

10. The system of claim 9, wherein the system comprises a Digital Network Architecture Center (DNAC) controller.

11. The system of claim 10, wherein the DNAC controller comprises a Non-Real Time (NRT) scheduler and a Real Time (RT) scheduler.

12. The system of claim 9, wherein the number of TxOPs to use for transmitting data between the AP and the client device over the wireless link are received from a Central Network Controller (CNC) of a Time Sensitive Network (CNC).

13. The system of claim 9, wherein the processing unit being operative to detect the change in the network condition of the wireless link comprises the processing unit being operative to predict the network condition of the wireless link based on tracking past movements of the client device and obtaining stochasticity of a signal received from the client device at different points in its past movement.

14. A computer-readable medium that stores a set of instructions which when executed performs a method comprising:
receiving a number of Transmit Opportunities (TxOPs) to use for transmitting data between an Access Point (AP) and a client device over a wireless link;
providing, based on the number of TxOPs, an initial gate configuration to the AP for transmitting data between the AP and the client device over the wireless link for a transmit period of each cycle of a number of cycles;
detecting a change in a network condition of the wireless link; and
adjusting the initial gate configuration for the transmit period in a current cycle of the number of cycles in response detecting the change in the network condition of the wireless link.

15. The computer-readable medium of claim 14, wherein providing the initial gate configuration to the AP comprises providing the initial gate configuration by a Non-Real Time (NRT) scheduler for the transmit period of each cycle of the number of cycles.

16. The computer-readable medium of claim 14, wherein receiving the number of TxOPs to use for transmitting data between the AP and the client device over the wireless link comprises receiving the number of TxOPs to use for transmitting the data between the AP and the client device based on a Radio Frequency (RF) profile associated with the wireless link.

17. The computer-readable medium of claim 14, wherein receiving the number of TxOPs to use for transmitting data between the AP and the client device over the wireless link comprises receiving the number of TxOPs for transmitting the data between the AP and the client device that is in motion.

18. The computer-readable medium of claim 14, wherein receiving the number of TxOPs to use for transmitting data between the AP and the client device over the wireless link comprises receiving the number of TxOPs from a Central Network Controller of a Time Sensitive Network (TSN).

19. The computer-readable medium of claim 14, wherein detecting the change in the network condition of the wireless link comprises predicting the network condition of the wireless link based on tracking past movements of the client device and obtaining stochasticity of a signal received from the client device at different points in its past movement.

20. The computer-readable medium of claim 14, wherein detecting the change in the network condition of the wireless link comprises detecting the change in the network condition of the wireless link based on a derivative of a Received Signal Strength Indicator (RSSI) received from the client device.
